(19) United States
(12) Patent Application Publication
(10) Pub. No.: US 2023/0249647 A1
(43) Pub. Date: Aug. 10, 2023

(54) MOVING BODY CONTROL DEVICE AND MOVING BODY CONTROL METHOD

(71) Applicant: HONDA MOTOR CO., LTD., Tokyo (JP)

(72) Inventors: Hisahiro Kato, Tokyo (JP); Hiroaki Hakukawa, Tokyo (JP); Takayuki Inomata, Tokyo (JP)

(21) Appl. No.: 18/155,984

(22) Filed: Jan. 18, 2023

(30) Foreign Application Priority Data
Feb. 8, 2022 (JP) 2022-017667

(51) Int. Cl. B60R 25/24; H04L 12/12; H04L 9/40

(52) U.S. Cl. CPC B60R 25/24; H04L 12/12; H04L 63/0876

(57) ABSTRACT

A moving body control device includes a first ECU and a second ECU. The first ECU has a power switch connected thereto and when user authentication using identification information stored in a storage unit has succeeded in a power-off state of a moving body, sets the moving body to a power-on state in response to operation of the power switch. The second ECU has a terminal device connected thereto and communicates with the first ECU. When recognizing a predetermined operation of the power switch in a state where the identification information is not stored in the storage unit in a power-off state of the moving body, the first ECU establishes communication with the second ECU, thereby allowing the terminal device to operate the first ECU via the second ECU.

### INCORPORATION BY REFERENCE

The present application claims priority under 35 U.S.C. § 119 to Japanese Patent Application No. 2022-017667 filed on Feb. 8, 2022. The content of the application is incorporated herein by reference in its entirety.

### BACKGROUND OF THE INVENTION

### Field of the Invention

The present invention relates to a moving body control device and a moving body control method.

### Description of the Related Art

In a known technique for a vehicle failure analysis system, failure analysis for a vehicle before delivery whose identification number has not been stored therein is performed under conditions that are different from those in a normal failure mode for a vehicle whose identification number has been stored therein (for example, see Japanese Patent Laid-Open No. 2012-126331).

In delivering a vehicle, a vehicle key and the vehicle are associated with each other and identification information of the vehicle key is stored in the vehicle to allow use of the vehicle only by the specific vehicle key. When authentication of the vehicle key held by a user has succeeded based on the identification information stored in the vehicle, power of the vehicle is turned on in response to the operation of a power switch of the vehicle by the user.

With such a configuration, power of the vehicle cannot be turned on by operation of its power switch before delivery of the vehicle, that is, when identification information of a vehicle key has not been stored in a vehicle. Thus, since the power of the vehicle before delivery cannot be turned on by operation of the power switch, it is, inconveniently, impossible to store the identification information of the vehicle key or perform diagnosis and the like of the vehicle for improving traffic safety and such purposes. One possible idea is to add, to the vehicle, a dedicated part for allowing the turning on of the power of the vehicle without the operation of the power switch; however, this leads to an increase in costs, which is not preferable.

The present invention has been made in view of the above background, and it is an object of the present invention to provide a moving body control device and a moving body control method that allow, with a lower cost configuration, turning on of power of a moving body such as a vehicle even when identification information used for user authentication has not been stored in the moving body.

### SUMMARY OF THE INVENTION

In a first aspect to achieve the above object, there is provided a moving body control device including: a storage unit that stores identification information used for user authentication of a moving body; a first ECU that has connected thereto a power switch for instructing to turn on power of the moving body and when the user authentication using the identification information stored in the storage unit has succeeded in a power-off state of the moving body, sets the moving body to a power-on state in response to the operation of the power switch; and a second ECU that is capable of having a terminal device connected thereto and performs communication with the first ECU. The first ECU establishes communication with the second ECU when recognizing a predetermined operation of the power switch in a state where the identification information is not stored in the storage unit in a power-off state of the moving body, thereby allowing the terminal device connected to the second ECU to operate the first ECU via the second ECU.

The above moving body control device may be configured so that the second ECU does not receive an operation instruction by the terminal device to the second ECU without establishment of communication between the first ECU and the second ECU, which is performed by the first ECU, even when the terminal device is connected to the second ECU in a power-off state of the moving body.

The above moving body control device may be configured so that the predetermined operation is that the power switch is operated continuously for a predetermined time or longer, and the first ECU starts processing of establishing communication with the second ECU when recognizing that the power switch is operated continuously for the predetermined time or longer in a state where the identification information is not stored in the storage unit in a power-off state of the moving body and stops the establishment processing when no longer recognizing the operation of the power switch before completing the establishment processing.

The above moving body control device may be configured so that a direct communication connection between the first ECU and the terminal device is impossible.

In a second aspect to achieve the above object, there is provided a moving body control method that is executed by a moving body control device including: a storage unit that stores identification information used for authentication of a user of a moving body; a first ECU that has connected thereto a power switch for instructing to turn on power of the moving body; and a second ECU that is capable of having a terminal device connected thereto and performs communication with the first ECU. The moving body control method includes: a normal operation mode step in which when authentication of the user using the identification information stored in the storage unit has succeeded in a power-off state of the moving body, the first ECU sets the moving body to a power-on state in response to the operation of the power switch; and a maintenance mode step in which when recognizing a predetermined operation of the power switch in a state where the identification information is not stored in the storage unit in a power-off state of the moving body, the first ECU establishes communication with a second ECU, thereby allowing the terminal device to operate the first ECU via the second ECU.

The above moving body control device and moving body control method allow the power of the moving body to be turned on in a state where identification information used for authentication of the user is not stored in the moving body, with lower cost configuration.

### BRIEF DESCRIPTION OF THE DRAWINGS

FIG. 1 is a block diagram of a moving body control device;

FIG. 2 is a flowchart of processing for establishing communication with a terminal device by a first ECU; and

FIG. 3 is an explanatory diagram of a procedure for establishing communication between the first ECU and the terminal device.

### DETAILED DESCRIPTION OF THE PREFERRED EMBODIMENTS

### 1. Configuration of Moving Body Control Device

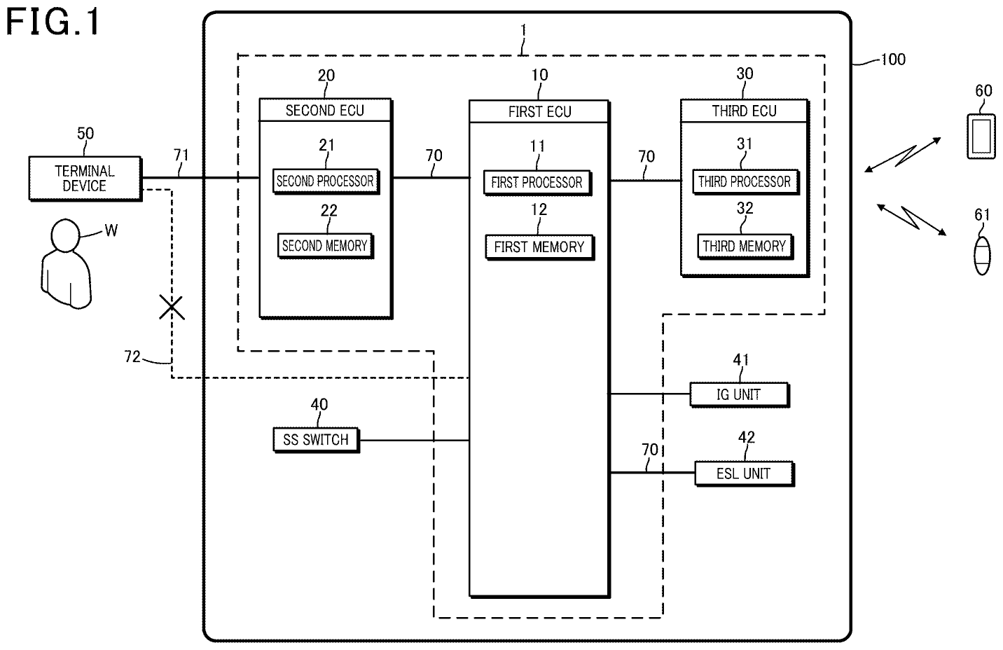

Referring to FIG. 1, the configuration of a moving body control device 1 will be described. The moving body control device 1 of one embodiment is included in a vehicle 100 (corresponding to a moving body of the present disclosure) and controls the operation of the vehicle 100. The moving body control device 1 includes a plurality of electronic control units (ECU) 10, 20, and 30.

The first ECU 10 is a control unit including a first processor 11, a first memory 12, and the like and executes a program stored in the first memory 12 to perform control for an area including a periphery of a driver's seat of the vehicle 100, control of power-on/power-off of the vehicle 100, and such controls. The first ECU 10 has connected thereto: a start/stop switch 40 (hereinafter referred to as a SS switch 40, which corresponds to a power switch of the present disclosure) for instructing to turn on and off power of the vehicle 100; and an ignition (IG) unit 41 for switching between power-on and power-off of the vehicle 100. In addition, the first ECU 10 has connected thereto an electric power steering lock (ESL) unit 42 by a first controller area network (CAN) 70.

The second ECU 20 is a control unit including a second processor 21, a second memory 22, and the like and executes a program stored in the second memory 22 to control the overall operation of the vehicle 100. The second ECU 20 is connected with the first ECU 10 by the first CAN 70, and has detachably connected thereto a terminal device 50 for maintenance of the vehicle 100 by a second CAN 71. An operator W connects the terminal device 50 to the second ECU 20 and performs maintenance work and the like in delivery of the vehicle 100. The terminal device 50 is, for example, a notebook personal computer (PC) or a tablet PC.

The third ECU 30 is a control unit including a third processor 31, a third memory 32, and the like and executes a program stored in the third memory 32 to perform authentication processing of a user of the vehicle 100. Specifically, the third ECU 30 authenticates the user by comparing a portable key 61 held by the user and identification information transmitted from a portable terminal 60 (more specifically, a virtual key application executed on the portable terminal 60) with identification information stored in the third memory 32. The portable terminal 60 is a communication terminal such as a smartphone, a portable telephone, or a tablet terminal, for example.

It should be noted that authentication processing for a user may be performed using biometric information (fingerprint, iris, facial image, and the like) of the user as identification information. The identification information is transmitted, in delivery of the vehicle 100, from the terminal device 50 to the third ECU 30 by the operation of the terminal device 50 by the operator W; and is stored in the third memory 32 (corresponding to the storage unit of the present disclosure). The third ECU 30 is connected to the first ECU 10 by the first CAN 70.

The first ECU 10 sets the vehicle 100 to a power-on state by an IG unit 41 when recognizing an operation of the SS switch 40 in a state where authentication of the portable terminal 60 or the portable key 61 by the third ECU 30 has succeeded. It is noted here that in the power-off state, the first ECU 10, the second ECU 20, and the third ECU 30 are in a sleep state in which less power is consumed than in an active state (normal operation state). However, even in the sleep state, the authentication of the portable terminal 60 or portable key 61 by the third ECU 30 and the recognition of the operation of the SS switch 40 by the first ECU 10 are executed so as to recognize the operation by the user to start using the vehicle 100.

In a power-off state, communication between the first ECU 10 and the second ECU 20 is disabled and if the terminal device 50 is connected to the second ECU 20, communication between the terminal device 50 and the first ECU 10 via the second ECU 20 is impossible. One possible idea is to place an additional wiring line 72 for directly connecting the terminal device 50 and the first ECU 10; however, it leads to an increase in costs. Under such circumstances, the first ECU 10 performs processing for enabling communication between the terminal device 50 and the first ECU 10 even when identification information has not been stored in the third memory 32 yet, such as before delivery of the vehicle 100. Hereinafter, this processing will be described.

### 2. Processing of Establishing Communication Between Terminal Device and First ECU

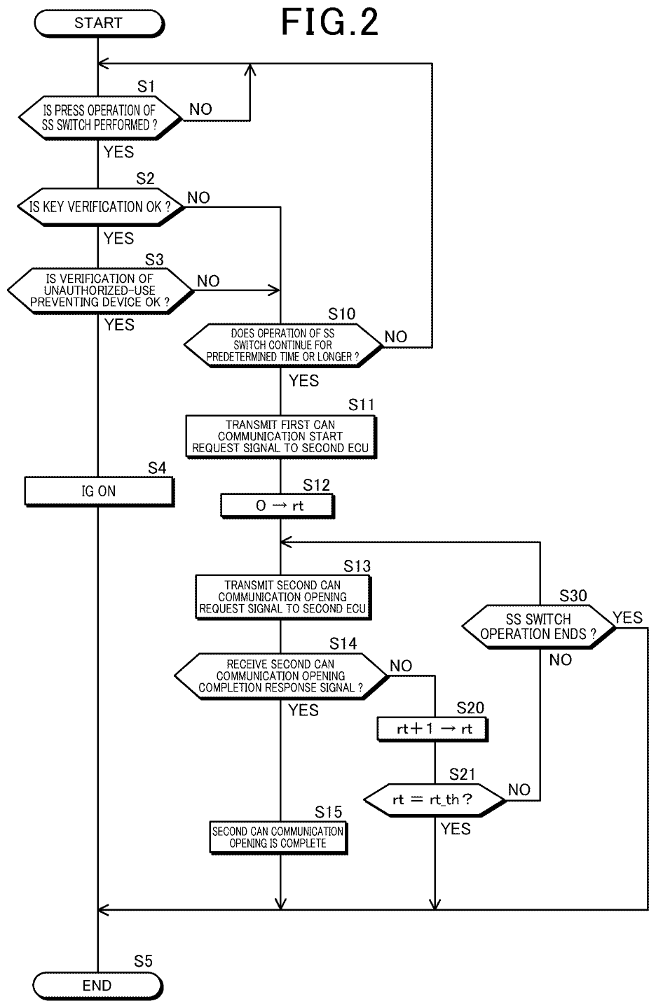

In accordance with a flowchart illustrated in FIG. 2, processing for enabling communication between the terminal device 50 and the first ECU via the second ECU 20, which is executed by the first ECU 10, will be described.

At step S1 in FIG. 2, if the first ECU 10 recognizes the operation of the SS switch 40 (press operation), it advances processing to step S2. At step S3, the first ECU 10 determines whether authentication of the portable terminal 60 or the portable key 61 by the third ECU 30 is complete (OK for key verification). If key verification is OK, the first ECU 10 advances processing to step S3 and if key verification is NG, it advances processing to step S10.

At step S3, the first ECU 10 determines whether verification of the registration of an unauthorized-use preventing device such as an ESL unit 42 is OK. If verification of the registration is OK, the first ECU 10 advances processing to step S4 and if verification of the registration is NG, it advances processing to step S10.

Step S4 is processing corresponding to a normal use start operation by a user of the vehicle 100, at which the first ECU 10 sets the vehicle 100 to a power-on state by the IG unit 41. Steps S10 to S14, S20, S21, and S30 are processing corresponding to cases where identification information has not been stored in the third memory 32 of the third ECU 30 and where an unauthorized-use preventing device such as the ESL unit 42 has not been registered.

At step S10, the first ECU 10 determines whether the operation of the SS switch 40 continues for a predetermined time (for example, several seconds) or longer, that is, the switch is being held down. If the operation of the SS switch 40 continues for the predetermined time or longer, the first ECU 10 advances processing to step S11; and if the operation of the SS switch 40 ends without continuing for the predetermined time or longer, it advances processing to step S1.

At step S11, the first ECU 10 transmits a communication start request signal for requesting the start of communication by the first CAN 70, to the second ECU 20. The second ECU 20 that has received the communication start request signal executes activation processing (wake-up processing) to transition from a sleep state to an active state. At the next step S12, the first ECU 10 executes loop processing of steps S13, S14, S20, S21, and S30 with 0 set as a retry variable rt.

At step S13, the first ECU 10 transmits a communication opening request signal for requesting the opening of communication between the second CAN 71 and the terminal device 50, to the second ECU 20. The second ECU 20 that has received the communication opening request signal executes processing for establishing communication with the terminal device 50. At the next step S14, the first ECU 10 determines whether it has received, from the second ECU 20, a second CAN communication opening completion response signal indicating that communication between the terminal device 50 and the second ECU 20 by the second CAN 71 has been opened.

Then, if receiving the second CAN communication opening completion signal, the first ECU 10 advances processing to step S15 to complete communication opening processing for the second CAN 71. If not receiving the second CAN communication opening completion signal, the first ECU 10 advances processing to step S20. At step S20, the first ECU 10 increments the retry variable rt (rt+1→rt); and at the subsequent step S21, determines whether the retry variable rt has reached a threshold value rt_th (which is, for example, set to 3 to 5).

If the retry variable rt becomes rt_th, the first ECU 10 advances processing to step S5. In this case, a possible cause is a failure in establishment of communication or the like between the terminal device 50 and the second ECU 20 due to a poor connection of the terminal device 50, or similar reason. On the other hand, if the retry variable rt does not reach the threshold rt_th, the first ECU 10 advances processing to step S30.

At step S30, the first ECU 10 determines whether the operation of the SS switch 40 ends. If the operation of the SS switch 40 ends, the first ECU 10 advances processing to step S5; and if the operation of the SS switch 40 continues, it advances processing to step S13 and executes processing of step S13 and subsequent steps again.

In the processing according to the flowchart illustrated in FIG. 2, the operator W causes, even when identification information for authenticating a user is not stored in the third memory 32 of the third ECU 30, establishment of communication between the terminal device 50 and the second ECU 20 by the second CAN 71 by holding down the SS switch 40, thereby enabling communication between the terminal device 50 and the first ECU 10.

Then, the operator W can provide an instruction to the first ECU 10 through the operation of the terminal device 50 so as to perform processing such as switching the vehicle 100 to a power-on state by the IG unit 41, storing the identification information to the third memory 32 by the third ECU 30, and registering the identification information to the ESL unit 42.

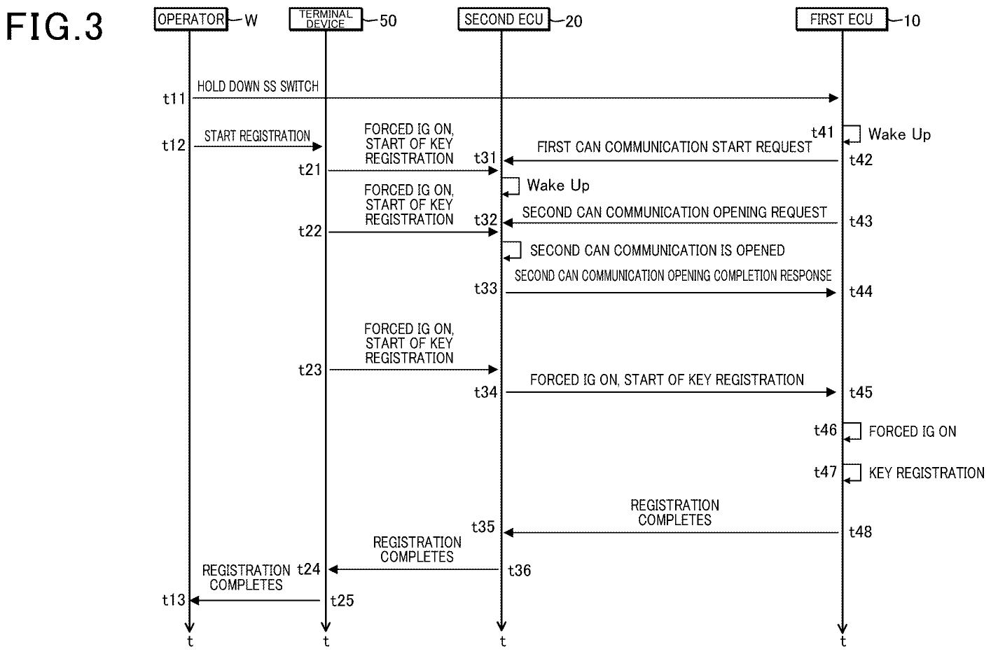

Next, FIG. 3 is an explanatory diagram illustrating, along a shared time axis t, a transition of processing by the operator W, the terminal device 50, the second ECU 20, and the first ECU 10 according to processing of the flowchart illustrated in FIG. 2 described above.

First, the operator W connects the terminal device 50 to the second ECU 20 and holds down the SS switch 40 at t11. In response to this hold-down operation, the first ECU 10 performs activation processing (wake-up processing) at t41, transitioning from a sleep state to an active state. At t42, the first ECU 10 transmits a first CAN 70 communication start request signal to the second ECU 20.

The second ECU 20 executes, when receiving the first CAN 70 communication start request signal at t31, activation processing (wake-up processing), transitioning from a sleep state to an active state, which establishes communication between the first ECU 10 and the second ECU 20. At t43, the first ECU 10 transmits a second CAN 71 communication opening request signal to the second ECU 20. The second ECU 20 executes, when receiving the second CAN 71 communication opening request signal at t32, processing for opening communication between the terminal device 50 and the second ECU 20 by the second CAN 71 and transmits, at t33 when the opening of the communication is complete, a communication opening completion response signal to the first ECU 10.

Here, the terminal device 50 transmits an instruction signal for forced IG ON and for start of key registration to the second ECU 20 at t21 and t22 in response to the operation by the operator W at t12; however, communication between the terminal device 50 and the second ECU 20 by the second CAN 71 has not been opened yet and therefore, the second ECU 20 has not received the signal. At t34 after communication between the terminal device 50 and the second ECU 20 is opened, the second ECU 20 receives an instruction signal for forced IG ON and for start of key registration which is transmitted from the terminal device 50; and transmits the instruction signal for forced IG On and for start of key registration to the first ECU 10. The operator W may also provide an instruction for, for example, registration of identification information in the ESL unit 42 described above, in addition to the one for forced IG ON and for start of key registration.

When receiving the instruction signal for forced IG ON and for start of key registration at t45 from the second ECU 20, the first ECU 10 sets the vehicle 100 to a power-ON state by the IG unit 41 at t46 and performs key registration processing at t47. The first ECU 10 transmits a registration completion signal indicating completion of the key registration, to the second ECU 20 at t48. The second ECU 20 receives the registration completion signal at t35 and transmits the registration completion signal to the terminal device 50 at t36.

When receiving the registration completion signal from the second ECU 20 at t24, the terminal device 50 displays a screen indicating completion of the key registration, on a display part at t25, to notify the operator W of the completion of the key registration.

### 3. Other Embodiments

In the above embodiment, a vehicle (including various vehicles such as a four-wheel vehicle, a two-wheel vehicle, a vehicle driven by an internal combustion engine, and an electric vehicle) is illustrated as a moving body; however, the moving body control device and moving body control method of the present disclosure can be applied also to a flying body, ship, and other kinds of moving bodies.

In the above embodiment, as a predetermined operation of the SS switch 40 (the power switch of the present disclosure), the operation of holding down the SS switch 40 for a predetermined time or longer is illustrated; however, the predetermined operation may be another operation mode such as pressing the SS switch 40 multiple times within a predetermined time.

Although FIG. 1 is a schematic diagram illustrating the moving body control device 1 in a manner in which the configuration thereof is divided according to the main processing contents for easy understanding of the present invention; however, the moving body control device 1 may be divided in other manners. In addition, processing of each component may be executed by one hardware unit or may be executed by a plurality of hardware units. Furthermore, processing of each component illustrated in FIG. 2 may be executed by one program or may be executed by a plurality of programs.

### 4. Configuration Supported by the Above Embodiment

The above embodiment is a specific example of the following configurations.

(Configuration 1) A moving body control device that includes: a storage unit that stores identification information used for authentication of a user of a moving body; a first ECU that has connected thereto a power switch for instructing to turn on power of the moving body and, when the user authentication using the identification information stored in the storage unit has succeeded in a power-off state of the moving body, sets the moving body to a power-on state in response to the operation of the power switch; and a second ECU that is capable of having a terminal device connected thereto and performs communication with the first ECU, wherein the first ECU establishes communication with the second ECU when recognizing a predetermined operation of the power switch in a state where the identification information is not stored in the storage unit in a power-off state of the moving body, thereby allowing the terminal device connected to the second ECU to operate the first ECU via the second ECU.

According to the moving body control device of configuration 1, the above moving body control device and moving body control method allow the power of the moving body to be turned on in a state where the identification information used for user authentication is not stored therein with lower cost configuration.

(Configuration 2) The moving body control device according to configuration 1, wherein the second ECU does not receive an operation instruction by the terminal device to the second ECU without establishment of communication between the first ECU and the second ECU by the first ECU even when the terminal device is connected to the second ECU in a power-off state of the moving body.

According to the moving body control device of configuration 2, the terminal device cannot operate the first ECU without establishment of communication between the first ECU and the second ECU which is performed in response to the predetermined operation of the power switch even when the terminal device is connected to the second ECU, thereby allowing security against unauthorized operation of the moving body control device by the terminal device to be enhanced.

(Configuration 3) The moving body control device according to configuration 1 or configuration 2, wherein the predetermined operation is that the power switch is operated continuously for predetermined time or longer and the first ECU starts processing of establishing communication with the second ECU when recognizing that the power switch is operated continuously for the predetermined time or longer in a state where the identification information is not stored in the storage unit in a power-off state of the moving body, and stops the establishment processing when no longer recognizing the operation of the power switch before completing the establishment processing.

According to the moving body control device of configuration 3, communication between the first ECU and the second ECU is established on condition that the power switch is continuously operated, thereby improving the reliability in performing maintenance by the terminal device.

(Configuration 4) The moving body control device according to any one of configuration 1 to configuration 3, wherein a direct communication connection between the first ECU and the terminal device is impossible.

According to the moving body control device of configuration 4, a direct connection between the first ECU and the terminal device is disabled, thereby reducing costs and preventing unauthorized connection of the terminal device to the first ECU.

(Configuration 5) A moving body control method that is executed by a moving body control device including: a storage unit that stores identification information used for authentication of a user of a moving body; a first ECU that has connected thereto a power switch for instructing to turn on power of the moving body; and a second ECU that is capable of having a terminal device connected thereto and performs communication with the first ECU, the moving body control method including: a normal operation mode step in which when authentication of the user using the identification information stored in the storage unit has succeeded in a power-off state of the moving body, the first ECU sets the moving body to a power-on state in response to the operation of the power switch; and a maintenance mode step in which when recognizing a predetermined operation of the power switch in a state where the identification information is not stored in the storage unit in a power-off state of the moving body, the first ECU establishes communication with the second ECU, thereby allowing the terminal device to operate the first ECU via the second ECU.

By executing the moving body control method of configuration 5 by the moving body control device, the same action and effect as those in the moving body control device of configuration 1 can be obtained.

### REFERENCE SIGNS LIST

1 moving body control device
10 first ECU
11 first processor
12 first memory
20 second ECU
21 second processor
22 second memory
30 third ECU
31 third processor
32 third memory
40 SS switch (power switch)
41 IG unit
42 ESL unit
50 terminal device
60 portable terminal
61 portable key
100 vehicle (moving body)
W operator

What is claimed is:

1. A moving body control device comprising:
a storage unit that stores identification information used for authentication of a user of a moving body;
a first ECU that has connected thereto a power switch for instructing to turn on power of the moving body, the first ECU setting the moving body to a power-on state in response to operation of the power switch when the authentication of the user using the identification information stored in the storage unit has succeeded in a power-off state of the moving body; and
a second ECU that is capable of having a terminal device connected thereto, the second ECU communicating with the first ECU,
wherein the first ECU establishes communication with the second ECU when recognizing a predetermined operation of the power switch in a state where the identification information is not stored in the storage unit in a power-off state of the moving body, thereby allowing the terminal device connected to the second ECU to operate the first ECU via the second ECU.

2. The moving body control device according to claim 1, wherein
the second ECU does not receive an operation instruction by the terminal device to the second ECU without establishment of communication between the first ECU and the second ECU, the establishment being performed by the first ECU, even when the terminal device is connected to the second ECU in a power-off state of the moving body.

3. The moving body control device according to claim 1, wherein
the predetermined operation is that the power switch is operated for a predetermined time or longer; and
the first ECU starts processing of establishing communication with the second ECU when recognizing that the power switch is operated continuously for the predetermined time or longer in a state where the identification information is not stored in the storage unit in a power-off state of the moving body, and stops the establishment processing when no longer recognizing the operation of the power switch before completing the establishment processing.

4. The moving body control device according to claim 1, wherein
a direct communication connection between the first ECU and the terminal device is impossible.

5. A moving body control method executed by a moving body control device, the moving body control device including:
a storage unit that stores identification information used for authentication of a user of a moving body;
a first ECU that has connected thereto a power switch for instructing to turn on power of the moving body; and
a second ECU that is capable of having a terminal device connected thereto and communicates with the first ECU,
the moving body control method comprising:
a normal operation mode step in which when authentication of the user using the identification information stored in the storage unit has succeeded in a power-off state of the moving body, the first ECU sets the moving body to a power-on state in response to operation of the power switch; and
a maintenance mode step in which when recognizing a predetermined operation of the power switch in a state where the identification information is not stored in the storage unit in a power-off state of the moving body, the first ECU establishes communication with the second ECU, thereby allowing the terminal device to operate the first ECU via the second ECU.
